(19) United States
(12) Patent Application Publication
(10) Pub. No.: US 2007/0279393 A1
(43) Pub. Date: Dec. 6, 2007

(54) Touch pad input device for electronic device and procedure for making the same

(76) Inventor: Kuo-Hsien Liu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/445,249

(22) Filed: Jun. 2, 2006

(51) Int. Cl. G06F 3/041

(52) U.S. Cl. 345/173

(57) ABSTRACT

A touch pad input device for an electronic device includes a shell, a touch pad and a pressing board. The shell has a step groove. The touch pad is disposed in the step groove, and the pressing board is adhered on the touch pad and the shell. Hence, the touch pad can be easily disposed and positioned in the groove of the shell. Further, the touch pad and the shell achieve a grounding effect easily.

### BACKGROUND OF THE INVENTION

1. Field of the Invention

The present invention relates to a touch pad input device, and in particular to a touch pad input device for an electronic device and the procedure for making the same.

2. Description of Prior Art

FIGS. 1 and 2 are an exploded view and a cross-sectional view showing the structure of a conventional touch pad of a computer. The conventional touch pad of a computer comprises a shell 100, a touch pad 103 and a thin board 105. The shell 100 has an accommodating space 101 and four fixing portions 102. By entering from the underside of the shell, the touch pad 103 is disposed within the accommodating space 101 of the shell 100. The thin board 105 has four positioning holes 1051. Screws 107 penetrate the four positioning holes 1051 of the thin board 105 and are positioned on the four fixing portions 102 of the shell 100, thereby to fix the touch pad 103 between the shell 100 and the thin board 105.

The conventional touch pad for a computer is disposed within the accommodating space 101 of the shell 100 by entering from the underside of the shell. However, such manner causes the inconvenience in disposing and difficulty in positioning.

Further, it is necessary for the conventional touch pad of a computer to use the screws 107 to penetrate the four positioning holes 1051 of the thin board 105 to be positioned on the four fixing portions 102 of the shell 100. In this way, the touch pad 103 can be fixed between the shell 100 and the thin board 105. Therefore, the conventional structure additionally needs one thin board 105 and screws 107 to fix the touch pad 103 on the shell 100, which causes the inconvenience in assembling. Further, when the thin board 105 is used to fix and support the touch pad 103, the supporting force of the thin board 105 is insufficient, which easily causes the breakage of the touch pad 103.

Therefore, according to the above, in practice, the conventional touch pad of a computer still has drawbacks and thus needs to be improved.

In view of the above, the inventor proposes the present invention to overcome the above problems based on his expert experiences and deliberate researches.

### SUMMARY OF THE INVENTION

The primary object of the present invention is to provide a touch pad input device for an electronic device and the procedure for making the same. With a shell having a step groove, the touch pad can be directly disposed in the groove of the shell from the underside of the shell. In this way, the touch pad can be easily disposed and positioned in the groove of the shell while enhancing the supporting force of the touch pad. Further, the bottom of the touch pad is formed with a metallic layer. With this metallic layer, the touch pad and the shell can easily achieve grounding effect.

In order to achieve the above objects, the present invention provides a touch pad input device for an electronic device, which comprises: a shell having a step groove; a touch pad disposed in the step groove; and a pressing board adhered on the touch pad and the shell.

The present invention further provides a procedure for making a touch pad input device for an electronic device, which comprises the steps of: providing a shell having a step groove; disposing a touch pad in the step groove; and adhering a pressing board on the touch pad and the shell.

In order to further understand the technique, means and functions employed by the present invention for achieving the desired objects, a detailed description relating to the present invention will be made with reference to the accompanying drawings so as to clearly explain the characteristics and the technical contents of the present invention. However, it should be understood that the drawings are illustrative but not used to limit the scope of the present invention.

### BRIEF DESCRIPTION OF THE DRAWINGS

FIG. 1 is an exploded view showing the structure of a conventional touch pad of a computer;

FIG. 2 is a cross-sectional view showing the structure of a conventional touch pad of a computer;

FIG. 3 is an exploded view showing the touch pad for an electronic device and the procedure for making the same in accordance with the present invention;

FIG. 4 is a cross-sectional view showing the touch pad for an electronic device and the procedure for making the same in accordance with the present invention;

FIGS. 4A and 4B are partially enlarged cross-sectional views showing the touch pad for an electronic device and the procedure for making the same in accordance with the present invention;

FIG. 5 is an exploded view showing the touch pad for an electronic device and the procedure for making the same in accordance with another embodiment of the present invention;

FIG. 6 is a cross-sectional view showing the touch pad for an electronic device and the procedure for making the same in accordance with another embodiment of the present invention;

FIGS. 6A and 6B are partially enlarged cross-sectional views showing the touch pad for an electronic device and the procedure for making the same in accordance with another embodiment of the present invention;

FIG. 7 is a schematic view showing the bottom of the touch pad of the present invention;

FIG. 8 is an exploded view showing the touch pad for an electronic device and the procedure for making the same in accordance with a further embodiment of the present invention; and

FIG. 9 is a flowchart showing the touch pad for an electronic device and the procedure for making the same in accordance with the present invention.

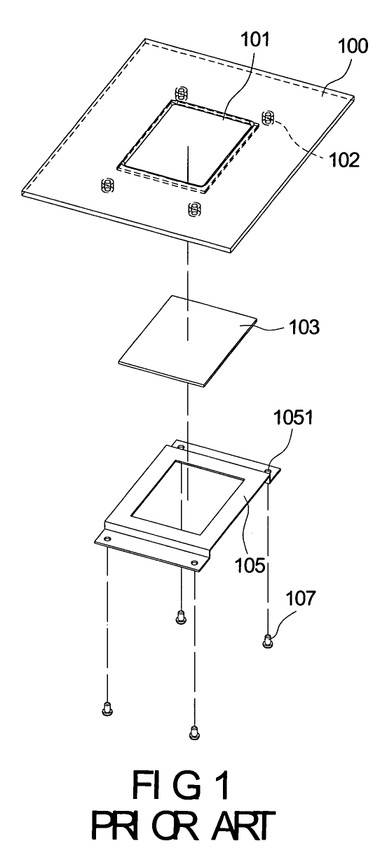

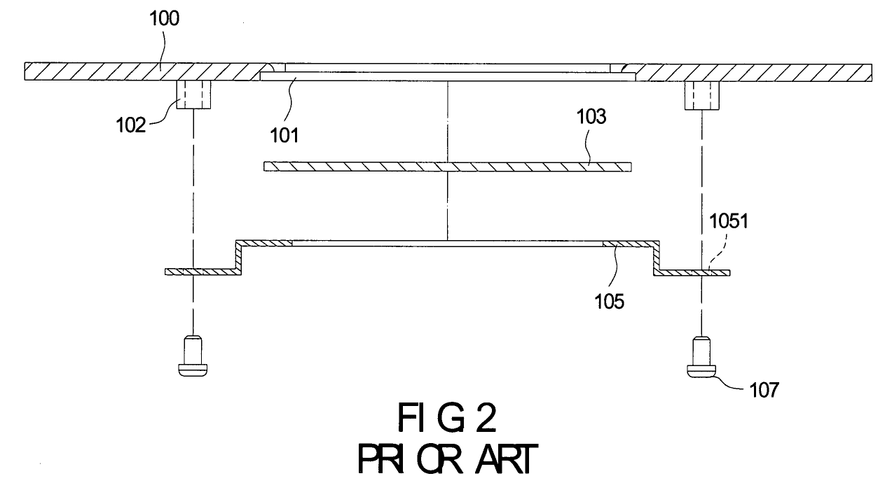

### DETAILED DESCRIPTION OF THE INVENTION

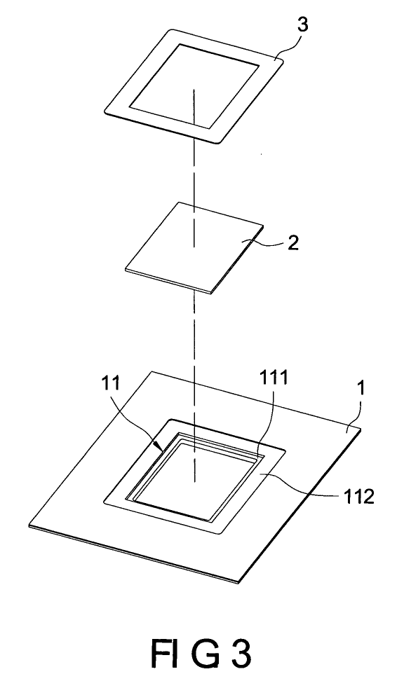

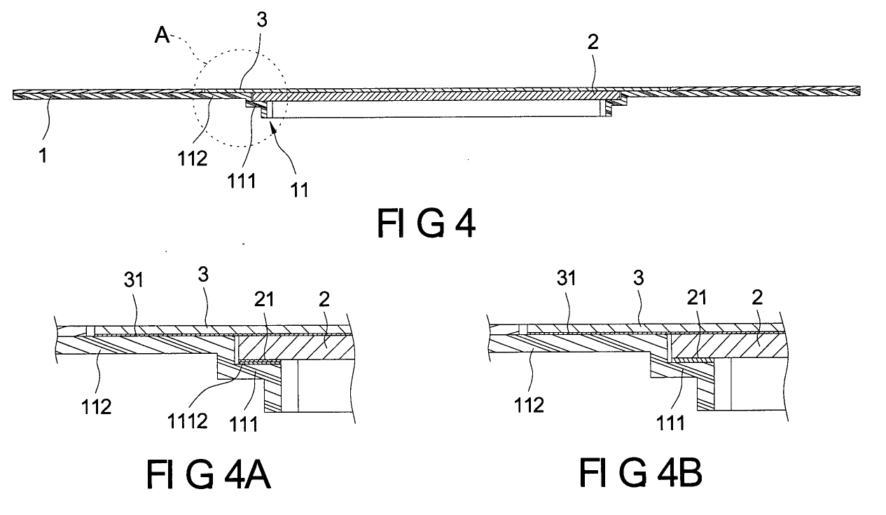

With reference to FIGS. 3 to 4B, an exploded view and cross-sectional views of the touch pad input device for an electronic device in accordance with the present invention are shown, respectively. The present invention comprises a shell 1, a touch pad 2 and a pressing board 3. The shell 1 has a step groove 11. The touch pad 2 is disposed in the step groove 11. The pressing board 3 is adhered on the touch pad 2 and the shell 1. The step groove 11 of the shell 1 comprises a first step groove 111 and a second step groove 112. The surface of the first step groove 111 of the shell 1 has a first contacting layer 1112. The first contacting layer 1112 is a metallic layer (as shown in FIG. 4A).

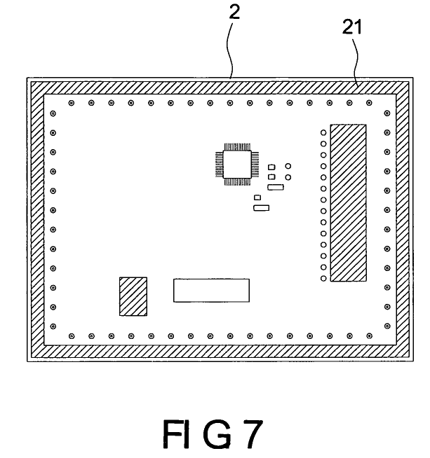

The bottom of the touch pad 2 has a second contacting layer 21. The second contacting layer 21 is a metallic layer (as shown in FIG. 7). The second contacting layer 21 is used for connecting to the first contacting layer 1112 of the shell 1. The bottom of the pressing board 3 has a waterproof glue layer 31. The glue layer 31 is adhered to the surface of the second step groove 112 of the shell 1 and the surface of the touch pad 2. When the shell 1 is a metallic shell, it is unnecessary to provide the first contacting layer 1112 (as shown in FIG. 4B). Since the metallic shell can directly ground together with the touch pad 2, the shell 1 is a metallic shell constituted of at least two sheet metals. When the shell 1 is a plastic shell, the first contacting layer 1112 is a metallic layer (as shown in FIG. 4A) for grounding together with the touch pad 2. The shell 1 is a plastic shell constituted of at least two plastic pieces.

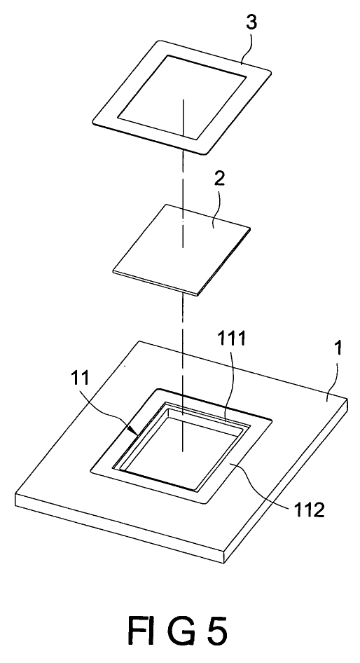

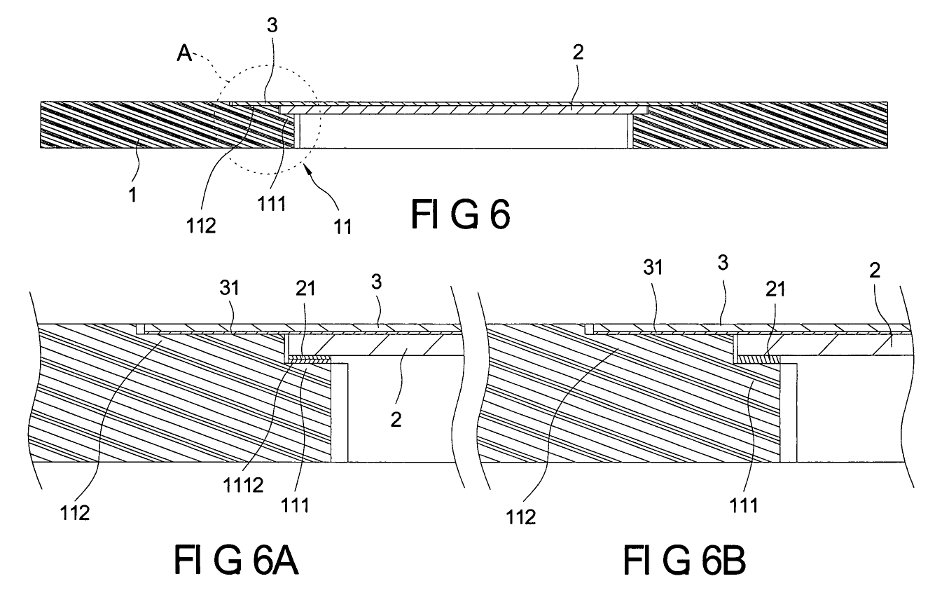

With reference to FIGS. 5 to 6B, an exploded view and cross-sectional views of the touch pad input device for an electronic device in accordance with another embodiment the present invention are shown, respectively. The present invention comprises a shell 1, a touch pad 2 and a pressing board 3. The shell 1 has a step groove 11. The touch pad 2 is disposed in the step groove 11. The pressing board 3 is adhered on the touch pad 2 and the shell 1. The step groove 11 of the shell 1 comprises a first step groove 111 and a second step groove 112. The surface of the first step groove 111 of the shell 1 has a first contacting layer 1112. The first contacting layer 1112 is a metallic layer (as shown in FIG. 6A).

The bottom of the touch pad 2 has a second contacting layer 21. The second contacting layer 21 is a metallic layer (as shown in FIG. 7). The second contacting layer 21 is used for connecting to the first contacting layer 1112 of the shell 1. The bottom of the pressing board 3 has a waterproof glue layer 31. The glue layer 31 is adhered to the surface of the second step groove 112 of the shell 1 and the surface of the touch pad 2. When the shell 1 is a metallic shell, it is unnecessary to provide the first contacting layer 1112 (as shown in FIG. 6B). Since the metallic shell can directly ground together with the touch pad 2, the shell 1 is integrally formed by one metallic shell. When the shell 1 is a plastic shell, the first contacting layer 1112 is a metallic layer (as shown in FIG. 6A) for grounding together with the touch pad 2. The shell 1 is integrally formed by one plastic shell.

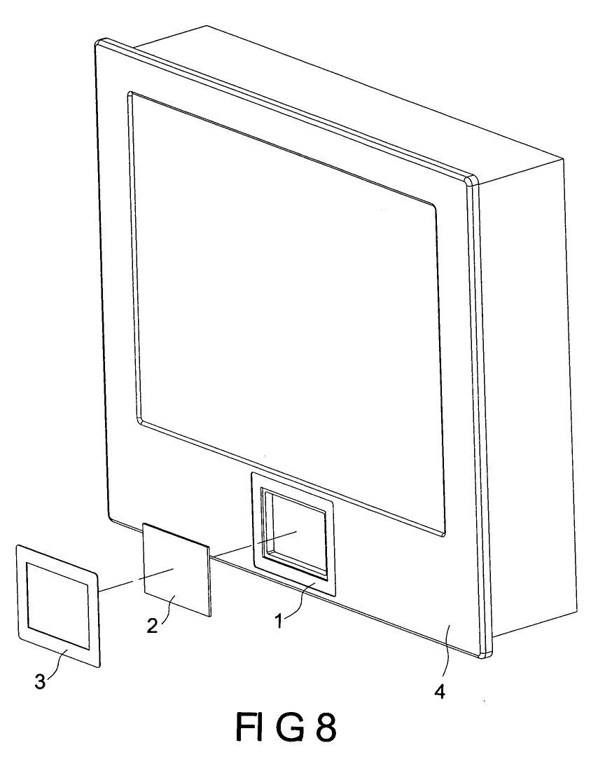

With reference to FIG. 8, it is an exploded view showing the touch pad for an electronic device in accordance with a further embodiment of the present invention. In the present embodiment, the pressing board 3 is adhered on the touch pad 2 and the shell 1, and can be applied to a liquid crystal display (LCD) panel 4. The touch pad 2 and the pressing board 3 are disposed on the shell 1 by entering from the front of the panel.

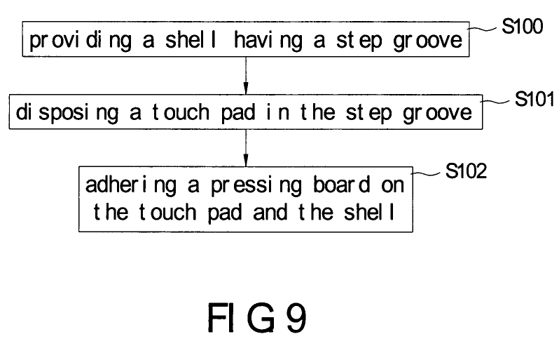

With reference to FIG. 9, it is a flowchart showing the touch pad for an electronic device and the procedure for making the same in accordance with the present invention, which comprises the steps of: providing a shell 1 having a step groove 11 (S100); disposing a touch pad 2 in the step groove 11 (S101); and adhering a pressing board 3 on the touch pad 2 and the shell 1 (S102).

The present invention is to provide a touch pad input device for an electronic device and the procedure for making the same. With the shell 1 having the step groove 11, the touch pad 2 can be directly disposed in the groove of the shell 1 by entering from the upside of the shell. In this way, the touch pad 2 can be easily disposed and positioned in the groove of the shell 1 while enhancing the supporting force of the touch pad 2. In addition, the pressing board 3 is adhered on the touch pad 2 and the shell 1 to have a waterproof effect.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A touch pad input device for an electronic device, comprising:
a shell having a step groove;
a touch pad disposed in the step groove; and
a pressing board adhered on the touch pad and the shell.

2. The touch pad input device for an electronic device according to claim 1, wherein the step groove of the shell comprises a first step groove and a second step groove.

3. The touch pad input device for an electronic device according to claim 2, wherein the surface of the first step groove of the shell has a first contacting layer, and the first contacting layer is a metallic layer.

4. The touch pad input device for an electronic device according to claim 3, wherein the bottom of the touch pad has a second contacting layer, and the second contacting layer is a metallic layer for connecting to the first contacting layer of the shell.

5. The touch pad input device for an electronic device according to claim 2, wherein the bottom of the pressing board has a waterproof glue layer, and the glue layer is adhered to the surface of the second step groove of the shell and the surface of the touch pad.

6. The touch pad input device for an electronic device according to claim 1, wherein the shell is a metallic shell.

7. The touch pad input device for an electronic device according to claim 6, wherein the shell is integrally formed by one metallic shell or is a metallic shell constituted of at least two sheet metals.

8. The touch pad input device for an electronic device according to claim 1, wherein the shell is a plastic shell.

9. The touch pad input device for an electronic device according to claim 8, wherein the shell is integrally formed by one plastic shell or is a plastic shell constituted of at least two plastic pieces.

10. A procedure for making a touch pad input device for an electronic device, comprising the steps of:
providing a shell having a step groove;
disposing a touch pad in the step groove; and
adhering a pressing board on the touch pad and the shell.

11. The procedure for making a touch pad input device for an electronic device according to claim 10, wherein step groove of the shell comprises a first step groove and a second step groove.

12. The procedure for making a touch pad input device for an electronic device according to claim 11, wherein the surface of the first step groove of the shell has a first contacting layer, and the first contacting layer is a metallic layer.

13. The procedure for making a touch pad input device for an electronic device according to claim 12, wherein the bottom of the touch pad has a second contacting layer, and the second contacting layer is a metallic layer for connecting to the first contacting layer of the shell.

14. The procedure for making a touch pad input device for an electronic device according to claim 11, wherein the bottom of the pressing board has a waterproof glue layer, and the glue layer is adhered to the surface of the second step groove of the shell and the surface of the touch pad.

15. The procedure for making a touch pad input device for an electronic device according to claim 10, wherein the shell is a metallic shell.

16. The procedure for making a touch pad input device for an electronic device according to claim 15, wherein the shell is integrally formed by one metallic shell.

17. The procedure for making a touch pad input device for an electronic device according to claim 15, wherein the shell is a metallic shell constituted of at least two sheet metals.

18. The procedure for making a touch pad input device for an electronic device according to claim 10, wherein the shell is a plastic shell.

19. The procedure for making a touch pad input device for an electronic device according to claim 18, wherein the shell is integrally formed by one plastic shell.

20. The procedure for making a touch pad input device for an electronic device according to claim 18, wherein the shell is a plastic shell constituted of at least two plastic pieces.
